(19) United States
(12) Patent Application Publication
(10) Pub. No.: US 2001/0027412 A1
(43) Pub. Date: Oct. 4, 2001

(54) Method and apparatus for providing advertisements

(76) Inventor: Won-Il Son, Seoul (KR)

Correspondence Address: RABIN & CHAMPAGNE, PC, 1101 14TH STREET, NW, SUITE 500, WASHINGTON, DC, 20005, US

(21) Appl. No.: 09/779,600

(22) Filed: Feb. 9, 2001

(30) Foreign Application Priority Data
Feb. 10, 2000 (KR) 2000-06289
Mar. 24, 2000 (KR) 2000-15129

(51) Int. Cl. G06F 17/60

(52) U.S. Cl. 705/14; 705/30

(57) ABSTRACT

A method and an apparatus for providing various advertisements via a network, such as the Internet. The method includes receiving an advertisement from a sponsor and/or advertising agent, providing the advertisement to a user, calculating an advertisement commission according to the advertisement provided to the user; and demanding the advertisement commission from a sponsor and/or advertising agent. An access commission is calculated and demanded from a sponsor and/or advertising agent, when the user links to an advertisement-related site by means of the advertisement. The apparatus includes a storage device and a processor coupled to the storage device. The storage device stores a program for controlling the processor and the processor is operative with the program to receive the advertisement from a sponsor and/or advertising agent, provide the advertisement to a user, calculate an advertisement commission according to the advertisement provided to the user, and demand the advertisement from a sponsor and/or advertising agent. The processor operates with the program to calculate an access commission and demand the access commission for the sponsor and/or the advertising agent, when the user links to an advertisement-related site by means of the advertisement.

### BACKGROUND OF THE INVENTION

The present invention relates to a method and apparatus for providing advertisements, and more particularly to a method and apparatus for providing all sorts of advertisements more effectively via a network, such as the Internet.

In general, an advertisement is produced for advertising a product or service through a medium, such as television or radio, so as to arouse a desire in the television audience or the radio listeners to buy or use the product or service advertised. An advertisement that makes use of video is called as a Commercial Film (CF).

The use of the Internet is increasing rapidly in pace with the continuing development of information and communication technology. Thus, advertisements that have been provided by means of television or radio can now be provided via the Internet.

Advertisements being supplied via the Internet, such as information about products or services, is provided at Internet shopping sites. Also, these advertisements are provided in the form of sash images via the Internet. /Advertisements are also provided in the form of sash images on the Internet.

At the present time, /In the case of such Internet advertising, information about a product or service is presented by means of an HTML file with a still image and a detailed explanation of the product or service that is being offered at an Internet shopping site. Internet

Also, advertisements of products or services provided in the form of sash images are called banner advertisements. By clicking on a banner advertisement, an Internet user can be linked to a site where he or she can search for detailed information about the advertisement. Every Internet Internet user is identified by the Internet Protocol (IP) address of Internet his/her terminal. The IP address is given to the Internet Internet user's server when Internet he/she connects to the Internet.

As described above, the advertisement supplied at a shopping site or the banner advertisement that provides a link to such a shopping is a still image advertising a product or service. A commission may be claimed by a sponsor whose site contains an advertising banner in accordance with the amount of exposure an advertisement has or the number of times an advertising banner is used.

However, in the conventional art, one drawback in estimating commissions based on an advertisement's amount of Internet exposure or how often an advertising banner is used is that it has been difficult to measure precisely an advertisement's degree of exposure.

Another problem with/weakness of the conventional art is that advertisements making use of still images alone do not provoke much interest in Internet users and are therefore not an effective means of providing advertising information. Furthermore, conventional methods are not effective in inspiring Internet users with a desire for more information about an advertisement, such as NG (No Good) information or information about an advertisement's production process, because there is nothing extraordinary about the advertising method. There is still another problem with the conventional art that a user cannot be identified precisely by their IP address in the case that the Internet user has a fluxional IP or does not use their own terminal.

### SUMMARY OF THE INVENTION

The present invention is intended to overcome the above-mentioned disadvantages of conventional Internet advertising methods. Therefore, it is an object of the present invention to provide a method and apparatus for advertising directly and more effectively by means of an advertising site that provides information about products and services.

Another object of the present invention is to provide a method and apparatus for using moving images in advertisements at an advertising site.

Another object of the present invention is to provide a method and apparatus for using an advertisement that is capable of measuring precisely its own degree of exposure by the number of times its moving image advertisement is downloaded. Also, it remains an object of the present invention to provide a method and apparatus for providing NG information and information related to an advertisement's production process as well as a normal advertisement.

Also, it remains an object of the present invention to provide a method and apparatus for providing an advertisement that is capable of effectively assisting a user connected to the advertising site by means of accessing personal information about the user when he/she logs onto the site. /enters the site.

In order to accomplish the objects of the present invention, according to one embodiment of the present invention, a method for providing advertisements is proposed that comprises the steps of: (1) receiving an advertisement from a sponsor or advertising agent; (2) providing this advertisement to users; /making this advertisement accessible to users; (3) estimating an advertising commission for providing the advertisement to users; and (4) demanding such an advertising commission from a sponsor and/or advertising agent (wherein an access commission is estimated based on the number of times users click on an advertising banner to link to a shopping site, and that commission is demanded from a sponsor and/or advertising agent).

The aforesaid advertisement is provided by at least one of the following means: a CF parade icon providing CF information in the form of normal image information and/or NG image information; a movie parade icon providing movie information in the form of normal image information and/or NG image information; a music video parade icon providing music video information in the form of normal image information and/or NG image information; an advertisement-related information icon providing information regarding advertisements (wherein such advertisement-related information may consist of information about people, music and places related to particular CF information,movie information, and/or music video information); a learning space icon providing expert knowledge as specified in an advertisement; a shopping icon providing a product specified in an advertisement; and a questionnaire icon for collecting opinions as specified in an advertisement.

In accordance with another preferred embodiment of the present invention, the apparatus for providing an advertisement is comprised of: a storage device connected with a processor. This storage device contains a program that controls the connected processor, which operates so as to: (1) receive advertisements from sponsors and/or advertising agents; (2) provide these advertisements to users; (3) estimate an advertising commission (according to an advertisement's amount of exposure); and (4) demand an advertising commission from a sponsor and/or advertising agent (wherein the aforesaid processor and program operate to estimate an access commission and demand that commission from a sponsor and/or advertising agent whenever a user links to an advertisement-related site by means of advertisements such as those described).

### BRIEF DESCRIPTIONS OF THE DRAWINGS

The present invention's achievement of the above objects and its other advantages will become more apparent in the detailed description of the preferred embodiments thereof and with reference to the attached drawings, in which:

FIG. 1 is a schematic diagram illustrating an apparatus for providing advertisements using the present invention;

FIG. 2 is a diagram illustrating a site map for providing advertisements using the present invention;

FIG. 3 is a flowchart illustrating a method for providing advertisements using the present invention;

FIG. 4 is a flowchart illustrating a method for providing an advertisement by clicking on a normal information icon;

FIG. 5 is a flowchart illustrating a method for providing an advertisement by clicking on a related advertisement icon;

FIG. 6 is a flowchart illustrating a method for providing an advertisement by clicking on an ‘NG playing space’ icon;

FIG. 7 is a flowchart illustrating a method for providing an advertisement by clicking on an ‘NG shopping’ icon;

FIG. 8 is a flowchart illustrating a method for providing an advertisement by clicking on an ‘NG questionnaire’ icon;

FIG. 9 is a flowchart illustrating a method for providing an advertisement by clicking on an ‘NG learning space’ icon;

FIG. 10 is a schematic view illustrating one example of a web log file's format;

FIG. 11 is a schematic view showing one example of a customer's profile according to the present invention.

### A key to numeric symbols referring to the major parts of the drawings

100: a sponsor or advertising agent

110: an advertisement user

120: an advertisement-providing server

130: a database

140: a shopping site

160:: a portal site

### DETAILED DESCRIPTION OF THE INVENTION

Hereinafter, the preferred embodiments of the present invention will be disclosed in more detail with reference to the accompanying drawings, but it is understood that the present invention should not be limited to the following embodiments.

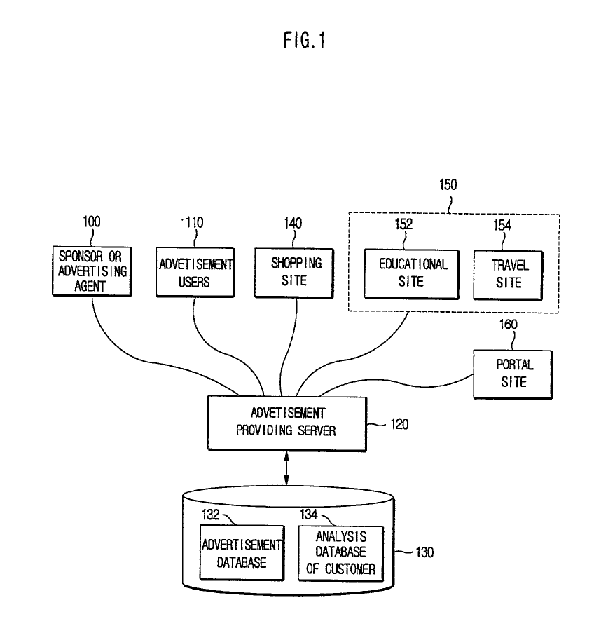

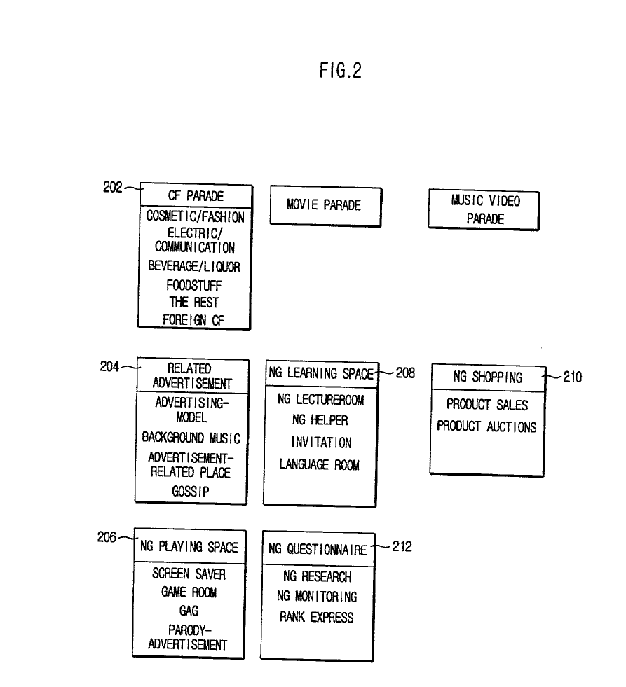

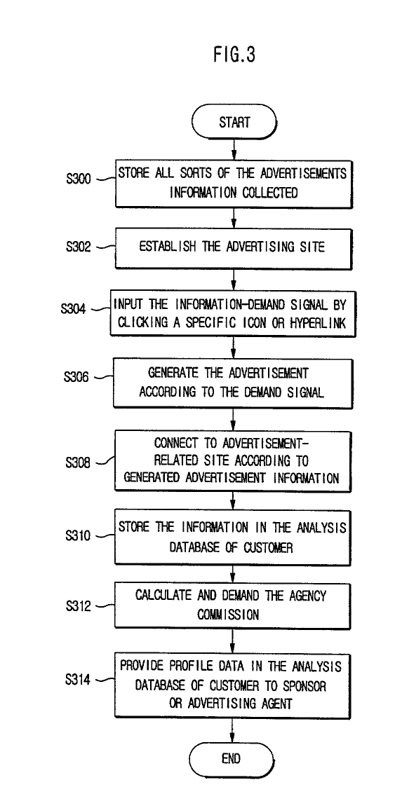

FIG. 1 is a schematic diagram illustrating an apparatus for providing advertisements using the present invention. FIG. 2 is a diagram illustrating a site map for providing advertisements using the present invention. Also, FIG. 3 is a flowchart illustrating a method for providing an advertisement.

Referring to FIG. 1, the apparatus for providing advertisements using the present invention comprises a sponsor or advertising agent (100), an advertisement user (110), an advertisement-providing server (120), a database (130), a shopping site (140), an advertisement-related site (150) and a portal site (160).

The database (130) comprises an advertisement database (132) and a customer-analysis database (134). Also, the shopping site (140) sells by auction books, properties or background music CDs related to advertisements. The advertisement-related site (150) comprises an educational site (152) with technical education concerning the advertisement or a travel site (154) with travel information related the advertisement.

The advertisement-providing server (120) is organized for storing in the advertisement database (132) all sorts of advertisements, such as NG information and normal advertisements, which are inputted by a sponsor or advertising agent (100).

Also, the advertisement-providing server (120) is organized for providing advertisements stored in the advertisement database (132) to an advertisement user (110) connected to a network, or for connecting an advertisement user (110) to a shopping site (140), an educational site (152) or a travel site (154).

In this embodiment of the invention, the advertisement-providing server (120) is organized for evaluating an advertisement on the basis of the demands of its users (110) or information about each connected site. The server stores the evaluation results in a custom-evaluation database (134) and provides the sponsor or advertising agent (100) with those results. It is easy to see how the operation of the apparatus for providing advertisements by using the present invention is comprised of the steps described above.

The advertisement-providing server (120) stores in the advertisement database (132) all sorts of advertisements, such as normal advertisements and NG information, which are inputted by a sponsor or advertising agent (100).

The advertisement-providing server (120) generates an advertising site with a homepage formatted as shown in FIG. 2 for providing advertisements to advertisement users (110) on the Internet.

Referring to FIG. 2, the homepage of the advertising site in the present invention comprises the following: (1) a ‘CF parade’ icon (202) for providing normal image information and NG image information of the CF; (2) a ‘related information’ icon (204) for providing appended information related to the advertisement; (3) an ‘NG playing space’ icon (206) for providing all sorts of games using the advertisement(including humor related to the advertisement and parody of it); (4) an ‘NG learning space’ icon (208) for providing expert knowledge related to the advertisement; (5) an ‘NG shopping’ icon (210) for selling all sorts of products related to the advertisement; and (6) a questionnaire icon (212) for collecting opinions from advertisement users (110) about the advertisement.

The homepage comprises the first and second stages of the advertising site. That is, the homepage is the main page of the advertising site.

In this embodiment of the present invention, advertisements are made according to their particular icons using Advanced Streaming Format files for still images, which are recognized by advertisement users (110).

The ‘CF parade’ icon (202) comprises a cosmetics/fashion hyperlink, an electronics/communications hyperlink, a beverage/liquor hyperlink, a foodstuff hyperlink, a rest hyperlink and a foreign advertisement hyperlink. All sorts of normal image information and NG image information provided by clicking on the hyperlinks can be obtained by downloading MPEG files.

According to another preferred embodiment of the present invention, normal image information and NG image information relating to a CF icon can be obtained directly by clicking on hyperlinks without downloading Also, the ‘related information’ icon (204) comprises an advertising model hyperlink, a background music hyperlink, an advertisement-related place hyperlink and a gossip hyperlink. Also, the ‘NG playing space’ icon (206) comprises a game room hyperlink, a gag hyperlink and a parody advertisement hyperlink. Also, the ‘NG learning space’ icon (208) comprises an NG lecture room hyperlink, an NG helper hyperlink and an invitation/language room hyperlink. The ‘NG shopping’ icon (210) comprises a product sales hyperlink and a product auctions hyperlink.

In addition, the questionnaire icon (212) comprises an NG research hyperlink, an NG monitoring hyperlink and a rank express hyperlink.

In this embodiment of the present invention, the advertising site may further comprise some icons or hyperlinks for providing normal-image and NG-image information concerning all sorts of movies and music videos.

The advertisement-providing server (120) selectively provides advertisements stored in its advertisement database (132) according to which icons and hyperlinks at the advertisement site are selected by users. When an advertisement user (110) clicks on a hyperlink linked with a certain related site, the advertisement-providing server (120) selectively connects the advertisement user (110) to a shopping site (140), an advertisement-related site (150), or a portal site (160).

In addition, the advertisement-providing server (120) stores inputted personal information about advertisement users (110) and their information needs (110) in a customer-analysis database (134).

The advertisement-providing server (120) charges agency commissions according to an analysis of the number of times an advertisement is downloaded, its retrieval time, and the profiles of advertisement users (110) at the advertisement site.

The advertisement-providing server (120) demands the agency commission from a sponsor or advertising agent (100).

In addition, the advertisement-providing server (120) charges an access fee according to an analysis of the number of connections or the time required for connections to shopping sites (140), advertisement-related sites (150) and/or portal sites (160).

The advertisement-providing server (120) demands an access fee from the managers shopping sites (140), advertisement-related sites (150) and portal sites (160).

The manner in which the apparatus of the present invention provides advertisements as described above will be described referring to FIG. 3.

First of all, the advertisement-providing server (120) stores all sorts of advertisements, such as normal-image advertisements, NG-image advertisements and advertisement-related information in the advertisement database (132) at Step 300. In this embodiment of the present invention, an advertisement is inputted by a sponsor or advertising agent (100).

Referring to FIG. 2, at Step 302, the advertising site is provided on the Internet with a site map for providing advertisements stored in the advertisement database (132). At Step 304, the advertisement user (110) logs onto the advertising site and inputs an information-demand signal by clicking a specific icon or hyperlink.

The advertisement-providing server (120) selectively generates an advertisement stored in the advertisement database (132) for the advertisement user (110) according to the information-demand signal received at Step 306.

For example, as a result of a user clicking on a CF information hyperlink in a CF parade icon (200), the advertisement-providing server (120) selectively generates for the advertisement user (110) normal image information which is stored in the advertisement database (132) and related to the selected CF. (1 10)Normal image information related to a CF can be obtained by downloading it to a certain memory location in the terminal of the advertisement user (110). On the other hand, the CF information can be accessed directly at the advertising site without downloading it.

In the case that CF information is accessed directly and not downloaded, normal image information related to the CF may contain certain program codes for monitoring the time that CF information is displayed on the terminal by the advertisement-providing server (120).

At Step 308, the advertisement-providing server (120) connects the advertisement user (110) to an advertisement-related site (150) according to which site related site the advertisement user (110) wishes to access.

At Step 310, the advertisement-providing server (120) stores information in the customer-analysis database (134) about an advertisement user's IP address, personal information, (110) selected advertisements, and links to advertisement-related sites. Information stored in the customer-analysis database (134) comprises personal information, such as the gender, age, occupation, hobbies, and advertisement selections of advertisement users, which is organized according to region.

The advertisement-providing server (120) calculates an agency commission according to the amount of output in advertisements and the required search time (measured on a percentage scale) and demands the agency commission from sponsors or advertising agents (100) at Step 312.

In addition, the advertisement-providing server (120) can calculate an agency commission according to the length of time links are made to shopping sites (140) or advertisement-related sites (150), and according to the number of purchases of a certain product, and then demand the agency commission.

Calculating and demanding a commission according to the length of time links are made to shopping sites (140) or advertisement-related sites (150) and according to the number of product purchases will now be described in more detail.

When an advertisement user (110) inputs a demand to purchase a certain product after connecting to a shopping site (140) or advertisement-related site (150), the advertisement-providing server (120) stores the input time of the demand signal and the details of the demand signal in the customer-analysis database (134).

Then, when the advertisement user (110) is linked to the shopping site (140) or advertisement-related site (150), the advertisement-providing server (120) transmits the customer ID of the advertisement user (110) to the database (not illustrated) of the shopping site (140) or advertisement-related site (150).

In this case, the database of the shopping site (140) or the advertisement-related site (150) contains information about purchases made by customers, which are organized according to customers' IDs. /contains information about purchases made using each customer's ID.

When the advertisement user (110) finishes purchasing products, information about the purchased products may be stored in the database of the shopping site (140), the advertisement-related site (150), and the customer analysis database (134) at the same time.

The advertisement-providing server (120) calculates the agency commission by comparing information about product stored in the database of a shopping site (140) or advertisement-related site (150) with the product purchase information stored in the customer-analysis database (134).

It is called web mining to manage a certain site effectively by means of a profile stored in a customer-analysis database (134) and to use that profile to calculate agency commissions.

The web mining of the apparatus for providing advertisements using the present invention will now be described.

The advertisement-providing server (120) identifies the advertisement user (110) by means of the user's IP address, ID and password.

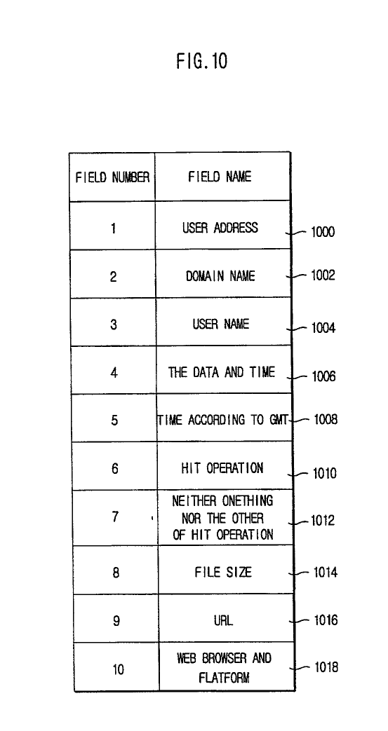

Referring to FIG. 10, a web log file is one kind of file format generated according to an advertisement user's identification.

Referring to FIG. 10, the web log file comprises eight standard fields and two extension fields: a user address field (1000) containing the IP address of a user connected to the site; a domain name field (1002); a user name field (1004); a field showing the date and time of connection to the site (1006); a time field according to Greenwich Mean Time (GMT) (1008); a hit operation field (1010) which records the number of times advertisement-related files are accessed; a default hit operation field (1012); a file size field (1014); an Internet site URL field (1016); and a web browser platform user field (1018).

A customer profile can be generated in a variety of formats according to the personal information of the advertisement user (110), such as detailed information about the customer, or information about the user's gender, location, age, log history, occupation, hobbies and school career. Referring to FIG. 10, the customer profile is generated after synchronizing the time data of the web log file with the data on the log-in time of the advertisement user (110) at the advertisement site.

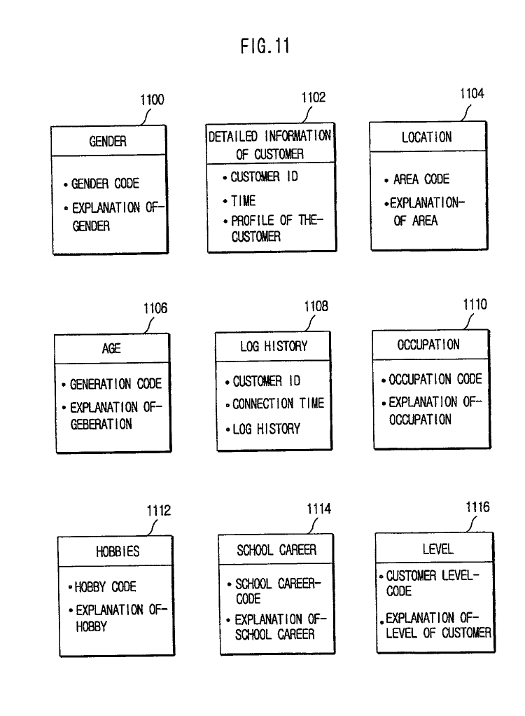

Referring to FIG. 11, a profile generated according to detailed information about a customer (1102) comprises a customer ID field, a time field, and a personal information field; and a customer profile generated according to a customer's gender (1100) comprises a gender code field and an explanation of the gender code field.

In addition, a profile generated according to a customer's location (1104) comprises an area code field and an explanation of the area code field. A profile generated according to a customer's age (1106) comprises a generation code field and an explanation of the generation code field. A profile generated according to a customer's log history (1108) comprises a customer ID field, a connection time field and a log history field. And, a profile generated according to a customer's occupation (1110) comprises an occupation code field and an explanation of the occupation code field.

In addition, a profile generated according to a customer's hobbies comprises a hobby code field and an explanation of the hobby code field. A profile generated according to a customer's school career comprises a school career code field and an explanation of the school career code field. And, a profile generated according to a customer's level comprises a customer level code field and an explanation of the customer level code field.

The advertisement-providing server (120) generates a profile using a log file, which is a record of a user's membership at an advertisement site. The log file comprises the advertisement user's personal information (e.g., gender, age, hobbies, location, and occupation). Then the advertisement-providing server (120) stores the profile in the customer-analysis database (134).

The advertisement-providing server (120) can manage the advertising site more effectively by analyzing customers according to their profiles stored in the customer-analysis database (134). The advertisement-providing server (120) may also do marketing by demanding an agency commission for providing customer profiles to sponsors or advertising agents.

A customer profile may either be provided to a sponsor or advertising agent (100) or be used for managing the advertisement site.

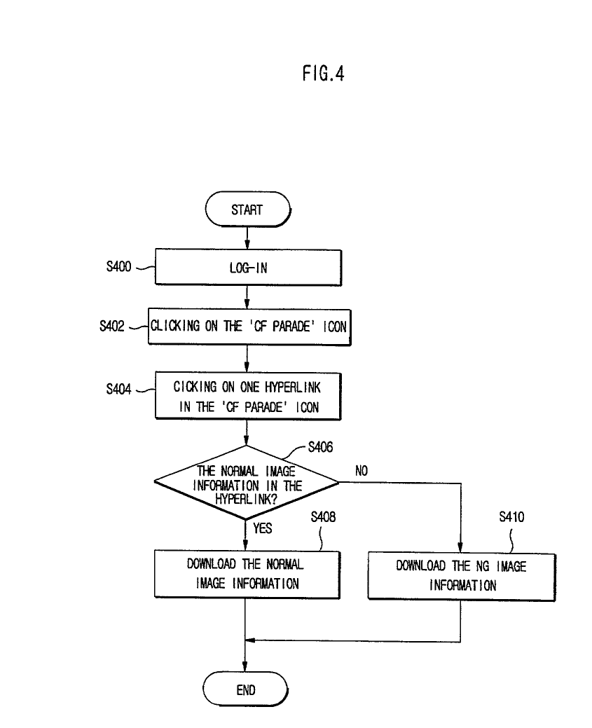

The method for providing information based upon the use of ° CF parade' icons in the apparatus for providing advertisements using the present invention will now be described referring to the FIG. 4.

FIG. 4 is a flowchart illustrating a method for providing advertisements when a ‘CF parade’ icon is clicked on.

First of all, at Step 400 the advertisement user (110) logs onto the advertising site. Then, at Step 402, the advertisement user inputs an information-demand signal by clicking on a ‘CF parade’ icon (200) at the advertising site.

At Step 404, the advertisement user (110) clicks on one hyperlink, such as a cosmetics/fashion hyperlink, an electronics/communications hyperlink, a beverage/liquor hyperlink, a foodstuff hyperlink, a rest hyperlink, or a foreign advertisement hyperlink./ . . . clicks on one of the following hyperlinks: . . . For example, the advertisement user (110) clicks on the cosmetics/fashion hyperlink in order to retrieve CF information related to cosmetics and fashion.

At Step 406, the advertisement-providing server (120) determines a demand signal according to which hyperlink was clicked on at Step 404, and also determines whether the demand signal is for normal information or NG information.

At Step 408, if the demand signal is for normal information, the advertisement-providing server (120) downloads the normal image information corresponding to the demand signal from the advertisement database (132) to a certain storage area at the terminal of the advertisement user (110).

In this case, an execution program can provide the normal image information of the CF because the CF is a moving picture.

On the other hand, at Step 410, if the demand signal is for NG information, the advertisement-providing server (120) downloads the corresponding NG image information of a CF from an advertisement database (132) to the terminal of the advertisement user (110). In addition, the advertisement user (110) may retrieve the NG information of a moving picture by executing the downloaded NG file.

The advertisement-providing server (120) may calculate the agency commission according to a predetermined percentage based upon the number of advertisements downloaded, and then demand the agency commission from a sponsor or advertising agent (100).

If the advertisement is a moving picture, the advertisement-providing server (120) generates a log file according to the particular advertisement downloaded by the advertisement user (110). Then the advertisement-providing server (120) counts the number of moving picture advertisements downloaded by checking the log file for streaming media and calculates the commission according to the number of downloaded advertisements and a predetermined commission percentage. In addition, the advertisement-providing server (120) stores customer-analysis information consisting of the customer's personal information and preferences in using/accessing advertisements. The customer-analysis information may be provided to a sponsor or advertising agent (100) and used for managing the advertisement site.

We will omit descriptions of the processes for obtaining advertisements by clicking on other hyperlinks among the ‘CF parade’ icons besides the cosmetics/fashion hyperlink because those processes are essentially the same as the one already described.

We will also omit a description of the process for obtaining information by clicking a ‘movie parade’ icon or ‘music video parade’ icon because it is essentially the same as the process for obtaining CF information by clicking on a ‘CF parade’ icon.

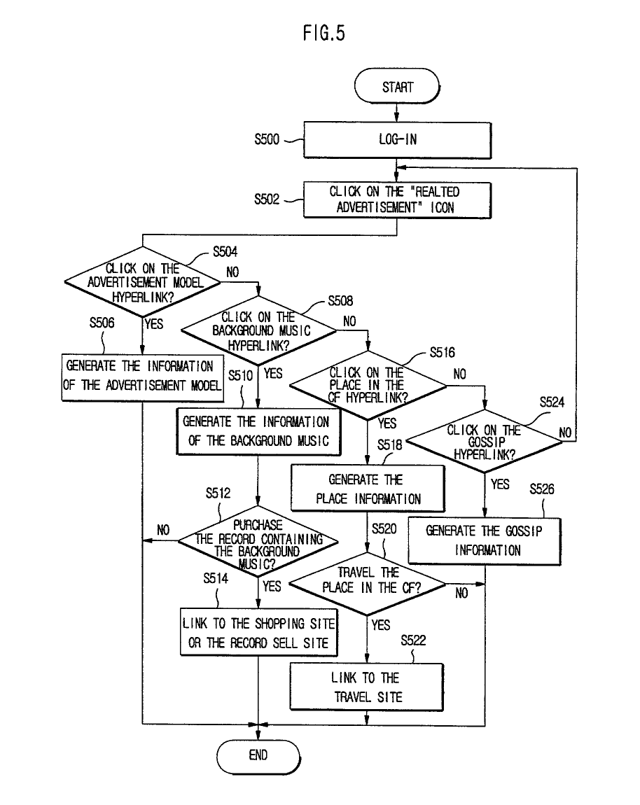

Referring to FIG. 5, we will now describe the method for obtaining information by clicking on the ‘related information’ icon of an advertising site.

FIG. 5 is a flowchart illustrating a method for providing advertisements when users click on an advertisement-related icon.

First of all, at Step 500, the advertisement user (110) logs onto an advertising site. Then, at Step 502, the user inputs an information-demand signal by clicking on a ‘related advertisement’ icon (204).

Then, the advertisement-providing server (120) determines which kind of information-demand signal is received/requested according to whether a customer clicks on an advertisement model hyperlink, a background music hyperlink, part of a CF hyperlink, or a gossip hyperlink.

That is, at Step 504, when an advertisement user (110) inputs a demand signal by clicking on an advertisement model hyperlink, the advertisement-providing server (120) generates information about the particular advertisement model, such as a CF, movie, or music video model. That information is then stored in an advertisement database (132) at Step 506.

Information about an advertisement model may comprise an image of the advertisement model and an explanation of it. In addition, information about an advertisement model may comprise a hyperlink that links the user to a homepage related to a particular advertising model.

On the other hand, if an advertisement user (110) inputs a demand signal for background music (Step 508), the advertisement-providing server (120) selectively generates/retrieves background music information (Step 510) from an advertisement database (132). If an advertisement user (110) wants to purchase a record containing background music (Step 512), the advertisement-providing server (120) links the advertisement user (110) to a shopping site (140) or a record sales site (not illustrated) at Step 514.

On the other hand, when an advertisement user (110) inputs a demand signal for place information in a CF by clicking on a place in the CF hyperlink at Step 516, the advertisement-providing server (120) selectively generates the place information in the CF (Step 518) which is stored in an advertisement database (132).

If an advertisement user (110) wants to surf a place in the CF at (Step 520), the advertisement-providing server (120) links the advertisement user (110) to a travel site (154) (Step 522).

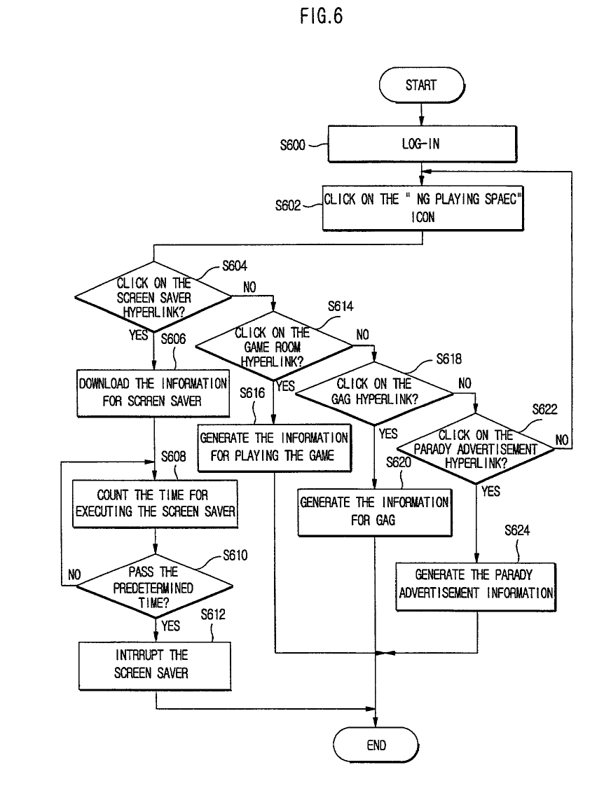

On the other hand, when an advertisement user (110) inputs a demand signal for gossip by clicking on a gossip hyperlink at Step 524, the advertisement-providing server (120) selectively generates gossip information related to the advertisement (Step 526), which is stored in an advertisement database (132). Referring to FIG. 6, we will now describe the method for providing information when a user clicks on an ‘NG playing space’ icon at the advertising site. FIG. 6 is a flowchart illustrating a method for providing an advertisement when a user clicks on an ‘NG playing space’ icon.

First of all, an advertisement user (110) logs onto the advertising site (Step 600) and then inputs an information-demand signal by clicking on an ‘NG playing space’ icon (206) (Step 602).

The advertisement-providing server (120) determines the kind of information-demand signal inputted according to whether the user clicked on a screensaver hyperlink, a game room hyperlink, a gag hyperlink, or a parody advertisement hyperlink.

That is, when the advertisement user (110) inputs a demand signal by clicking on a screensaver hyperlink (Step 604), the advertisement-providing server (120) selects screensaver image information stored in the advertisement database (132) and sends it to the terminal of the advertisement user (110) (Step 606).

Then, starting when the screensaver image program is executed (Step 608), the advertisement-providing server (120) counts the time that the screensaver image is displayed at the user's terminal. Then, when a predetermined time has passed (Step 610), the advertisement-providing server (120) interrupts the screensaver image information displayed on the terminal (Step 612).

The advertisement-providing server (120) interrupts the screensaver image information displayed on the terminal in order to demand that the advertisement user (110) pay for using the screensaver image information.

On the other hand, when the advertisement user (110) inputs the demand signal according to clicking on the game room hyperlink at the step 614, the advertisement-providing server (120) generates selectively a game information for playing a certain game stored in the advertisement database 132 to the advertisement user (110) at the step 616. The game may be executed according to clicking on the game room hyperlink provided by a still image of the advertisement.

On the other hand, when the advertisement user (110) inputs the demand signal by clicking on a gag hyperlink (Step 618), the advertisement-providing server (120) selects corresponding humorous information stored in the advertisement database (132) and sends it to the advertisement user (110) (Step 620).

On the other hand, when the advertisement user (110) inputs a demand signal by clicking on a parody advertisement hyperlink (Step 622), the advertisement-providing server (120) selects a parody advertisement adapted from the CF and stored in the advertisement database (132), and then sends it to the advertisement user (110) (Step 624).

The parody advertisement may be transmitted by e-mail. It may also be provided as moving image information and comprise a flash file.

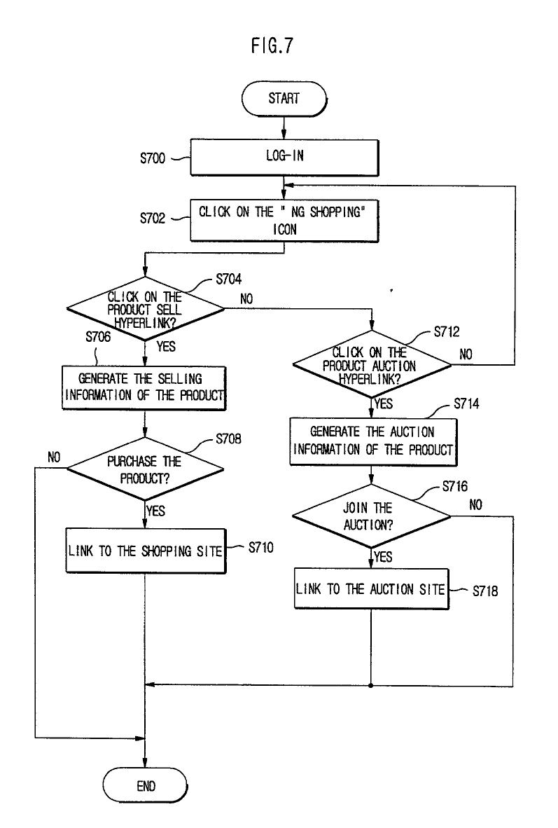

Referring to FIG. 7, we will now describe the method for providing information by clicking on an ‘NG shopping’ icon at the advertising site.

FIG. 7 is a flowchart illustrating a method for providing advertisements when a user clicks on an ‘NG shopping’ icon.

First of all, an advertisement user (110) logs onto the advertising site (Step 700). Then he inputs an information-demand signal by clicking on an ‘NG shopping’ icon (210) (Step 702).

The advertisement-providing server (120) determines the kind of information-demand signal inputted according to whether a user clicks on a product sales hyperlink or product auction hyperlink. All products are related to the advertisement. The advertisement user (110) inputs personal information such as an ID and a password when he/she logs onto the advertisement site.

When the advertisement user (110) inputs a demand signal by clicking on a product sales hyperlink, the advertisement-providing server (120) accesses and displays information stored in the advertisement database (132) about the product related to the advertisement (Step 706).The sales information about the advertised product may be provided using a CF, a movie or a music video.

First, an advertisement user (110) inputs a demand signal for purchasing a product related to an advertisement (Step 708). The advertisement-providing server then (120) links the advertisement user (110) to the shopping site which sells the product related to the advertisement (Step 710). The shopping site sends the product to the advertisement user (110) if the advertisement user (110) inputs an account number at the shopping site or pays to purchase the product.

On the other hand, when an advertisement user (110) inputs a demand signal by clicking on a product auction hyperlink (Step 712), the advertisement-providing server (120) accesses and displays auction information stored in the advertisement database (132) about the product related to the advertisement (Step 714).

Then, if the advertisement user (11 0) wants to participate in an auction (Step 716), the advertisement-providing server (120) connects the advertisement user (110) to the auction site (Step 718).

The auction site sends a product to the advertisement user (110) if the advertisement user (110) inputs the highest bidding price and an account number at the auction site or pays to purchase the product.

As described above, the advertisement-providing server (120) calculates an agency commission according to the number of times or length of time a user clicks on a button with sales or auction information, and the server then charges the agency commission to the corresponding sponsor or advertising agent (100).

In addition, the advertisement-providing server (120) may calculate an access charge according to the number of links advertisement users (110) make with shopping sites or auction sites and then demand the access charge from the corresponding shopping sites or auction sites.

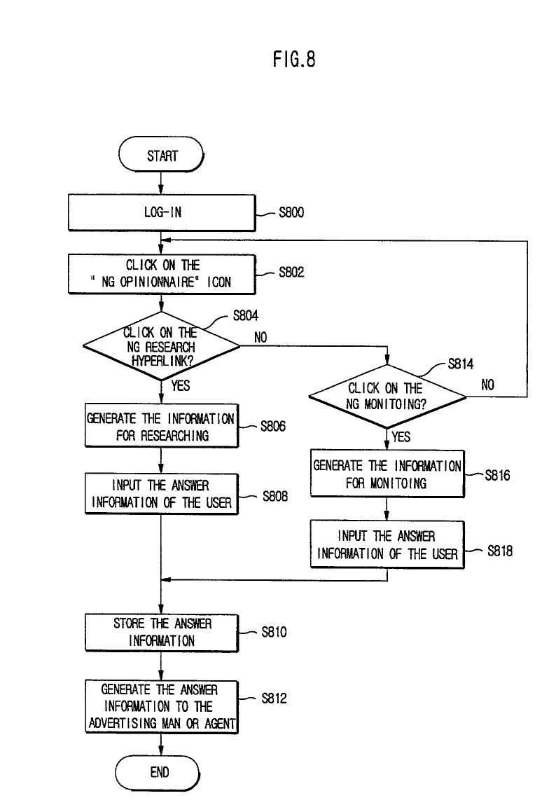

Referring to FIG. 8, we will now describe the method for providing information when an advertisement user clicks on an ‘NG questionnaire’ icon at an advertising site.

FIG. 8 is a flowchart illustrating a method for providing advertisements when a user clicks on an ‘NG questionnaire’ icon.

First of all, an advertisement user (110) logs onto an advertising site (Step 800) and inputs a demand signal by clicking on an ‘NG questionnaire’ icon (212) (Step 802).

The advertisement-providing server (120) determines which kind of demand signal is inputted according to whether the user clicks on an NG research hyperlink, an NG monitoring hyperlink, or a rank express hyperlink.

When the advertisement user (110) inputs a demand signal by clicking on an NG research hyperlink (Step 804), the advertisement-providing server (120) accesses and displays a research questionnaire so that the advertisement user (110) can record his/her opinions about the advertising site in the advertisement database (132) (Step 806).

For example, the research questionnaire contains questions such as, “What style of advertisements do you like?” and, “Who is your favorite CF star?”

The advertisement user (110) inputs answers to the questions (Step 808), and the advertisement-providing server (120) stores the answer information in that advertisement user's customer analysis database (134) (Step 810).The answer information stored in the customer analysis database (134) may be selectively provided to sponsors or advertising agents (100) (Step 812).

On the other hand, when an advertisement user (110) inputs a demand signal by clicking on an NG monitoring hyperlink (Step 814), the advertisement-providing server (120) displays a site monitoring page to collect information from the advertisement user (110) about his/her opinions concerning the advertisements provided at the advertising site (Step 816). In this case, the site monitoring page contains questions such as, “What is your favorite advertisement at the advertisement site?” and, “What is the worst advertisement at the advertisement site, and why is it the worst?” The advertisement user (110) inputs answer information to the site monitoring page (Step 818), and the advertisement-providing server (120) stores the answer information in the customer-analysis database (134) (Step 810). The answer information stored in the customer-analysis database (134) may be selectively provided to sponsors or advertising agents (100) (Step 812).

A description of the process for providing advertisements when a user clicks on a rank express hyperlink may be omitted because it is essentially the same as the process for providing advertisements described above.

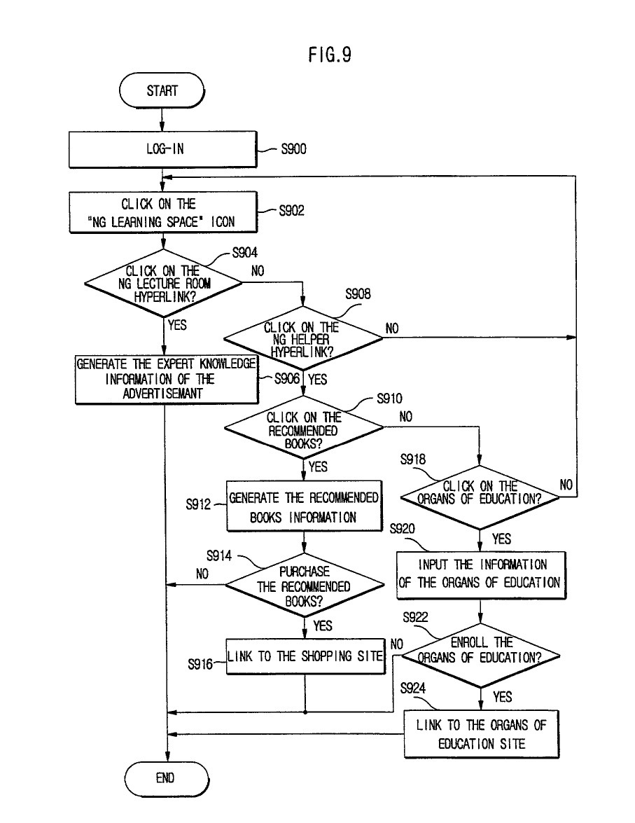

Referring to FIG. 9, we will now describe the method for providing information when a user clicks on an ‘NG learning space’ icon at the advertising site.

FIG. 9 is a flowchart illustrating a method for providing advertisements when a user clicks on an ‘NG learning space’ icon.

First of all, an advertisement user (110) logs onto the advertising site (Step 900). Then he/she inputs an information-demand signal by clicking on an ‘NG learning space’ icon (208) (Step 902).

The advertisement-providing server (120) determines which kind of information-demand signal is inputted according to whether the user clicks on an NG lecture room hyperlink, an NG helper hyperlink, or an invitation/language room hyperlink. The advertisement user (110) inputs a demand signal by clicking on an NG lecture room hyperlink (Step 904). Then the advertisement-providing server (120) accesses and displays corresponding information from experts about the advertisement that is stored in the advertisement database (132) (Step 906).This information from experts concerns all aspects of the advertisement.

On the other hand, when an advertisement user (110) inputs a demand signal by clicking on an NG helper hyperlink (Step 908), the advertisement-providing server (120) determines which kind of demand signal is inputted according to whether the user clicks on an icon for information on recommended books related to the advertisement or one for information on educational organizations.

When the advertisement user (110) inputs a demand signal by clicking on an icon for information on recommended books related to the advertisement (Step 910), the advertisement-providing server (120) accesses and displays the corresponding information stored in the advertisement database (132(Step 912). Information on recommended books may be updated continuously as that information is provided by a book sales site linked to the advertisement site.

When the advertisement user (110) inputs a demand to purchase any recommended books (Step 914), the advertisement-providing server (120) links the advertisement user (110) to the appropriate shopping site (140) which sells the desired book(s) (Step 916).

On the other hand, when an advertisement user (110) inputs a demand signal for information on an educational institution related to the advertisement (Step 918), the advertisement-providing server (120 accesses and displays the corresponding information stored in the advertisement database (132) (Step 920). If the advertisement user (110) inputs a demand signal to enroll in an educational institution (Step 922), the advertisement-providing server (120) links the advertisement user (120) to the educational institution's site (Step 924). The advertisement user (110) may then enroll in that educational institution by following the enrollment procedures specified at that institution's site.

A description of the process for providing advertisements when a user selects an invitation/language room hyperlink may be omitted because it is essentially the same as the process described above.

As described above, a commission may be calculated according to the number of times an icon is selected or the period of time an advertisement is displayed at the advertising site, and the commission may be demanded from the appropriate sponsors or advertising agents. In addition, the personal information inputted by the advertisement user (110) when he/she logs onto the advertising site and the advertisements outputted at his/her demand are stored. A commission may also be demanded from sponsors, advertising agents, or linked sites for providing them with stored information about advertisement users. In addition, while an advertisement user retrieves an advertisement, he/she may chat with other advertisement users.

Using the present invention's apparatus and method for providing advertisements, all sorts of advertisements of products, movies or music videos may be provided at the advertising site by means of motion picture images. As a result, advertisements may evoke a greater desire in Internet users to retrieve information.

In addition, because advertisements using motion picture images may be displayed on the terminal of the Internet user by downloading and executing those files, a commission may be calculated based on the number of files that are downloaded and the time it takes to retrieve advertisements. /and the retrieval time for advertisements. In addition, management of the advertising site and marketing can be accomplished more effectively by the use of web mining which analyses the advertisement preferences of users by referring to their IP information, personal information and search request information.

In addition, the desire of advertisement users to retrieve advertisements may be satisfied by providing them with NG advertisements as well as normal advertisements. So, the length of time users are linked with the advertising site may increase through having access to more various advertisements.

It is to be understood that the above description is only of the preferred embodiment of the invention. The present invention may be further modified within the spirit and scope of this disclosure.

This application is therefore intended to cover any variations, uses or adaptations of the invention using its general principles. Further, this application is intended to cover such departures from the present disclosure as come within known or customary practice in the art to which this invention pertains.

1. A method for providing advertisements comprising the steps of:
receiving an advertisement from at least one source selected from a group consisting of sponsors and advertising agents;
providing said advertisement to a user;
estimating an advertising commission according to the type of advertisement and manner of providing it to the said user; and
demanding said advertising commission from at least one source selected from a group consisting of sponsors and advertising agents;
wherein an access commission is estimated and demanded from at least one source selected from a group consisting of sponsors and advertising agents when said user links to an advertisement-related site by means of said advertisement.

2. The method for providing an advertisement as claimed in claim 1, wherein the step of demanding said advertising commission from at least one source selected from a group consisting of sponsors and advertising agents comprises the steps of:
renewing a log file for recording the number of times said advertisement are provided to said user;
estimating the number of said advertisements that are provided to said user by analyzing the log file using streaming media; and
estimating said advertising commission by applying a predetermined commission rate to said estimated number of advertisements provided to a user.

3. The method for providing an advertisement as claimed in claim 1, further comprising the steps of:
generating a log file for said user; and
converting said log file into a plurality of profiles according to the personal information of said user by using time data stored in said log file.

4. The method for providing an advertisement as claimed in claim 3, wherein said personal information comprises at least one kind of information selected from the group consisting of gender, area, log history, occupation, hobby, school career, and customer level.

5. The method for providing an advertisement as claimed in claim 1, wherein further comprising the steps of:
storing data about the time duration and contents of links with said advertisement-related site; and
estimating said access commission by applying a predetermined commission rate to said contents of a link.

6. The method for providing an advertisement as claimed in claim 1a, wherein the advertisement comprises at least one kind of information selected from a group consisting of: normal image information, No Good (NG) image information, and advertisement-related information about Commercial Films (CF), movies, and music videos.

7. The method for providing an advertisement as claimed in claim 1, wherein said advertisement is provided by at least one kind of icon selected from a group consisting of:
a CF parade icon for providing at least one kind of DF information selected from a group consisting of said normal image information and said NG image information;
a movie parade icon for providing at least one kind of movie information selected from a group consisting of said normal image information and said NG image information; a music video parade icon for providing at least one kind of music video information selected from a group consisting of said normal image information and said NG image information;
a related information icon for providing said advertisement-related information, wherein said advertisement-related information is at least one kind of information selected from a group consisting of information about related persons, music and places related to said CF information, and said movie or music video information;
a learning space icon for providing expert information about said advertisement;
a shopping icon for providing a product advertised by said advertisement; and
a questionnaire icon for collecting opinions about said advertisement.

8. The method for providing an advertisement as claimed in claim 7, further comprising the steps of:
receiving an information-demand signal according to which icon is selected by said user from among a group of icons consisting of said CF parade icon, said movie parade icon and said music video parade icon; and
providing one kind of information selected from a group consisting of said CF information, said movie information and said music video information according to said information-demand signal received from said user.

9. The method for providing an advertisement as claimed in claim 8,wherein the step of providing one selected from the group consisting of said CF information, said movie information and said music video information according to said information-demand signal for said user is accomplished by downloading.

10. The method for providing an advertisement as claimed in claim 8, wherein said downloaded information is a moving image picture.

11. The method for providing an advertisement as claimed in claim 7, wherein further comprising the steps of:
receiving an information-demand signal according to clicking on said related information icon from said user;
providing at least one advertisement-related information corresponding to said information-demand signal to the user, said advertisement-related information being one selected from the group consisting of a personal information, a music information, a place information and a gossip information about said CF information, said movie information and said music video information; and
providing an access for a site related to the advertisement-related information to the user.

12. The method for providing an advertisement as claimed in claim 7, further comprising the steps of:
receiving an information-demand signal according to clicking on said learning space icon from said user;
providing at least one advertisement-related information corresponding to said information-demand signal to the user, said advertisement-related information being one selected from the group consisting of an advertising knowledge, books related to said advertisement and an educational organ information related to said advertisement; and
providing an access to a site related to the advertisement-related information to the user.

13. The method for providing an advertisement as claimed in claim 7, wherein further comprising the steps of:
receiving an information-demand signal according to clicking said opinionnaire icon from said user;
selecting a pertinent information in accordance with said information-demand signal, said pertinent information being one selected from the group consisting of researching, monitoring and rank deciding; and
providing the pertinent information to said user.

14. The method for providing an advertisement as claimed in claim 7, further comprising the steps of:
receiving an information-demand signal according to clicking on said shopping icon;
providing a pertinent information according to said information-demand signal for said user; and
linking a related site corresponding to said pertinent information.

15. An apparatus for providing an advertisement, comprising:
a storage device; and
a processor coupled to said storage device,
said storage device storing a program for controlling said processor; and
said processor operative with said program to receive an advertisement from at least one source selected from a group consisting of sponsors and advertising agents;
provide said advertisement to a user;
estimate an advertising commission according to the type of advertisement and manner of providing it to the said user; and
demand said advertising commission from at least one source selected from a group consisting of sponsors and advertising agents;
wherein an access commission is estimated and demanded from at least one source selected from a group consisting of sponsors and advertising agents when said user links to an advertisement-related site by means of said advertisement.

16. The apparatus for providing an advertisement as claimed in 15, wherein said processor further operate with said program to generate a log file for said user; and
to convert said log file into a plurality of profiles according to the personal information of said user by using time data stored in said log file.

17. The apparatus for providing an advertisement as claimed in 16, wherein the personal information comprises at least one kind of information selected from the group consisting of information about gender, age, occupation, hobby, area, school career and log history.

18. The apparatus for providing an advertisement as claimed in 15, wherein said processor further operate with said program to store data about the time duration and contents of links with said advertisement-related site; and
to estimate said access commission by applying a predetermined commission rate to said contents of a link.

19. The apparatus for providing an advertisement as claimed in 15, wherein the advertisement comprises at least one kind of information selected from the group consisting of normal image information, No Good (NG) image information and knowledge information of Commercial File (CF) information, movie information, music video information. intended to cover such departures from the present disclosure as come within known or customary practice in the art to which this invention pertains.
